(19) United States
(12) Patent Application Publication
(10) Pub. No.: US 2024/0056988 A1
(43) Pub. Date: Feb. 15, 2024

(54) DEVICE AND METHOD FOR HANDLING MULTIPLE SIM TRANSMISSION POWER RESTRICTIONS

(71) Applicant: Apple Inc., Cupertino, CA (US)

(72) Inventors: Alexander Sayenko, Munich (DE); Daniel Popp, Munich (DE); Anatoliy S. Ioffe, Sunnyvale, CA (US); Fucheng Wang, Cupertino, CA (US); Camila Priale Olivares, Munich (DE)

(21) Appl. No.: 18/087,399

(22) Filed: Dec. 22, 2022

Related U.S. Application Data
(60) Provisional application No. 63/396,431, filed on Aug. 9, 2022.

(51) Int. Cl. H04W 52/36; H04W 52/42

(52) U.S. Cl. CPC H04W 52/367; H04W 52/42

(57) ABSTRACT

User equipment to transmit signals (e.g., concurrently) using multiple SIMs. If the user equipment determines to perform transmission power back-off due to operating using the multiple SIMs (MuSIM operation), the user equipment sends an indication to each network corresponding to each SIM that it is performing the power back-off. If a network supports MuSIM operation, then the user equipment sends an indication that it is performing the power back-off due to MuSIM operation (e.g., an MuSIM Maximum Power Reduction (M-MPR) indication). For such a network, it is assumed that the M-MPR indication would be standardized under an applicable specification. If a network does not support MuSIM operation (e.g., a legacy network), then the user equipment leverages a legacy power back-off indication (e.g., a Power Management Maximum Power Reduction (P-MPR) indication) to indicate to the network that it is performing a power back-off.

### CROSS-REFERENCE TO RELATED APPLICATIONS

This application claims priority to U.S. Provisional Application No. 63/396,431, filed Aug. 9, 2022, entitled “DEVICE AND METHOD FOR HANDLING MULTIPLE SIM TRANSMISSION POWER RESTRICTIONS,” the disclosure of which is incorporated by reference herein in its entirety for all purposes.

### BACKGROUND

The present disclosure relates generally to wireless communication, and more specifically to user equipment having multiple subscriber identity modules (SIMs).

User equipment (e.g., commercially available user equipment) may support more than one SIM (e.g., more than one SIM card, more than one embedded SIM (eSIM), more than one digital SIM, and so on). However, a capability of using more than one SIM (e.g., to transmit wireless signals) may not be fully supported by current telecommunication specifications (e.g., the Third Generation Partnership Project (3GPP) specification).

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, user equipment includes a first transmitter, a second transmitter a first subscriber identity module (SIM) communicatively coupled to the first transmitter, a second SIM communicatively coupled to the second transmitter, and processing circuitry communicatively coupled to the first transmitter and the second transmitter. The processing circuitry transmits, using the first transmitter and the first SIM, a first indication of a first transmission power reduction. The processing circuitry also transmits, using the second transmitter and the second SIM, a second indication of a second transmission power reduction. The processing circuitry further decreases the first transmission power at the first transmitter, and decreases the second transmission power at the second transmitter. The processing circuitry also transmits, using the first transmitter and the first SIM, a first signal. The processing circuitry further transmits, using the second transmitter and the second SIM, a second signal.

In another embodiment, a method performed by user equipment includes activating, via processing circuitry of the user equipment, a first subscriber identity module (SIM) of the user equipment. The method also includes activating, via the processing circuitry, a second SIM of the user equipment. The method further includes transmitting, via a first transmitter of the user equipment and the first SIM, a first indication of a first transmission power reduction based on using the first SIM and the second SIM. The method also includes decreasing, via the processing circuitry, first transmission power at the first transmitter. The method further includes transmitting, via the first transmitter and the first SIM, a first signal.

In yet another embodiment, a method performed by an electronic device of a network includes receiving a first indication that user equipment has activated a first subscriber identity module (SIM). The method also includes receiving a second indication that the user equipment is decreasing transmission power based on using the first SIM and a second SIM. The method further includes configuring the user equipment based on the second indication.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of an user equipment, according to embodiments of the present disclosure;

FIG. 2 is a functional diagram of the user equipment of FIG. 1 having multiple subscriber identity modules (SIMs), according to embodiments of the present disclosure;

FIG. 3 is a schematic diagram of a wireless communication system including the user equipment of FIG. 1, according to embodiments of the present disclosure;

FIG. 4 is a schematic diagram of different maximum power reductions (MPRs) for transmission power of the user equipment of FIG. 1 as specified by a legacy specification (e.g., the Third Generation Partnership Project (3GPP) specification), according to embodiments of the present disclosure;

FIG. 5 is a schematic diagram of different maximum power reductions (MPRs) for transmission power of the user equipment of FIG. 1 as specified by a proposed specification that supports user equipment having multiple SIMs, according to embodiments of the present disclosure;

FIG. 6 is a flowchart of a method for performing a power back-off with a legacy wireless communication network (e.g., that does not support user equipment having multiple SIMs) and where the power back-off due to operating with multiple SIMs is not standardized, and/or a network that supports user equipment having multiple SIMs (e.g., a MuSIM network), according to embodiments of the present disclosure;

FIG. 7 is a flowchart of a method for performing a power back-off with a legacy wireless communication network (e.g., that does not support user equipment having multiple SIMs) and where the power back-off due to operating with multiple SIMs is standardized, and/or a MuSIM network, according to embodiments of the present disclosure; and

FIGS. 8A and 8B are a flowchart of a method that illustrates actions by the user equipment of FIG. 1, a legacy network, and a MuSIM network, when the user equipment performs the method of FIG. 7, according to embodiments of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on. Additionally, the term “set” may include one or more. That is, a set may include a unitary set of one member, but the set may also include a set of multiple members.

This disclosure is directed to user equipment having multiple subscriber identity modules (SIMs). User equipment (e.g., commercially available user equipment) may support more than one SIM (e.g., more than one SIM card, more than one embedded SIM (eSIM), more than one digital SIM, and so on). However, a capability of using more than one SIM was not fully supported by current telecommunication specifications (e.g., the Third Generation Partnership Project (3GPP) specification). As a result, in some cases, user equipment-specific implementations for multiple SIMs might behave differently. For example, in some implementations, only one SIM might be active at a given time. That is, simultaneous or concurrent operation of the multiple SIMs might not be supported. One common problem of operating with multiple SIMs is that user equipment might miss a paging notification addressed to one of the SIMs (e.g., while it is inactive). Another common problem is the user equipment reporting a “device unavailable” status due to an inactive SIM when there is an active session on the other SIM.

In its release 17 (Rel-17), the 3GPP addressed downlink operations for multi-SIM (MuSIM) user equipment that may receive signals using only one SIM at a given time or two SIMs simultaneously. However, the 3GPP has not addressed multiple simultaneous uplink operations using MuSIM user equipment. In particular, when performing MuSIM transmissions, if the user equipment cannot sustain a desired (e.g., maximum) transmission power using each SIM, then it may back-off of the desired transmission power (e.g., perform a power back-off). Moreover, if transmission using a first SIM (e.g., at a first frequency) and transmission using a second SIM (e.g., at a second frequency) results in intermodulation issues, then the user equipment may also back-off transmission power using each SIM to avoid such issues. Additionally, if transmission using a first SIM on a first frequency occurs simultaneously or concurrently with reception using a second SIM on a second frequency, the user equipment may back-off transmission power using the first SIM to ensure reception using the second SIM (e.g., if the first frequency and the second frequency are in the same frequency band as specified by a specification, such as the 3GPP specification). In each of these cases, the reduction in transmission power may violate existing specifications (e.g., the 3GPP specification), which may not allow such power back-off (e.g., due to MuSIM operation).

It should be noted that one particular embodiment of backing-off transmission power may include setting an uplink transmission chain (e.g., transmitter) power to zero, effectively performing fallback to a single transmitter mode. This may be suitable when the user equipment and/or user settings indicate that a main, preferred, or prioritized SIM should get better or best service (e.g., higher power, higher signal quality, and so on). As a modified version of this embodiment, the user equipment may allocate decreased or minimum transmission power for the second SIM to main uplink control signals, but not a data channel.

Embodiments herein provide various devices and methods to enable user equipment to transmit signals using multiple SIMs. In particular, if the user equipment determines to perform transmission power back-off due to operating using the multiple SIMs (MuSIM operation), the user equipment sends an indication to each network corresponding to each SIM that it is performing the power back-off. If a network supports MuSIM operation (e.g., a multiple SIM or MuSIM network), then the user equipment sends an indication that it is performing the power back-off due to MuSIM operation (e.g., a MuSIM Maximum Power Reduction (M-MPR) indication). For such a network, it is assumed that the M-MPR indication would be standardized under an applicable specification. If a network does not support MuSIM operation (e.g., a legacy network), then the user equipment leverages a legacy power back-off indication (e.g., a Power Management Maximum Power Reduction (P-MPR) indication) to indicate to the network that it is performing a power back-off. If it is standardized to use the legacy P-MPR for performing power back-off due to MuSIM operation, then the user equipment follows the standard when using P-MPR. In some embodiments, the user equipment may also send an indication that it is using P-MPR to perform power back-off due to MuSIM operation, if such an indication is standardized. If it is not standardized to use the legacy P-MPR for performing power back-off due to MuSIM operation, then the user equipment may follow internal (to the user equipment) rules for performing power back-off.

FIG. 1 is a block diagram of user equipment 10, according to embodiments of the present disclosure. The user equipment 10 may include, among other things, one or more processors 12 (collectively referred to herein as a single processor for convenience, which may be implemented in any suitable form of processing circuitry), memory 14, nonvolatile storage 16, a display 18, input structures 22, an input/output (I/O) interface 24, a network interface 26, and a power source 29. The various functional blocks shown in FIG. 1 may include hardware elements (including circuitry), software elements (including machine-executable instructions) or a combination of both hardware and software elements (which may be referred to as logic). The processor 12, memory 14, the nonvolatile storage 16, the display 18, the input structures 22, the input/output (I/O) interface 24, the network interface 26, and/or the power source 29 may each be communicatively coupled directly or indirectly (e.g., through or via another component, a communication bus, a network) to one another to transmit and/or receive signals between one another. It should be noted that FIG. 1 is merely one example of a particular implementation and is intended to illustrate the types of components that may be present in the user equipment 10.

By way of example, the user equipment 10 may include any suitable computing device, including a desktop or notebook computer (e.g., in the form of a MacBook®, MacBook® Pro, MacBook Air®, iMac®, Mac® mini, or Mac Pro® available from Apple Inc. of Cupertino, California), a portable electronic or handheld electronic device such as a wireless electronic device or smartphone (e.g., in the form of a model of an iPhone® available from Apple Inc. of Cupertino, California), a tablet (e.g., in the form of a model of an iPad® available from Apple Inc. of Cupertino, California), a wearable electronic device (e.g., in the form of an Apple Watch® by Apple Inc. of Cupertino, California), and other similar devices. It should be noted that the processor 12 and other related items in FIG. 1 may be embodied wholly or in part as software, hardware, or both. Furthermore, the processor 12 and other related items in FIG. 1 may be a single contained processing module or may be incorporated wholly or partially within any of the other elements within the user equipment 10. The processor 12 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processors 12 may include one or more application processors, one or more baseband processors, or both, and perform the various functions described herein.

In the user equipment 10 of FIG. 1, the processor 12 may be operably coupled with a memory 14 and a nonvolatile storage 16 to perform various algorithms. Such programs or instructions executed by the processor 12 may be stored in any suitable article of manufacture that includes one or more tangible, computer-readable media. The tangible, computer-readable media may include the memory 14 and/or the nonvolatile storage 16, individually or collectively, to store the instructions or routines. The memory 14 and the nonvolatile storage 16 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 12 to enable the user equipment 10 to provide various functionalities.

In certain embodiments, the display 18 may facilitate users to view images generated on the user equipment 10. In some embodiments, the display 18 may include a touch screen, which may facilitate user interaction with a user interface of the user equipment 10. Furthermore, it should be appreciated that, in some embodiments, the display 18 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input structures 22 of the user equipment 10 may enable a user to interact with the user equipment 10 (e.g., pressing a button to increase or decrease a volume level). The I/O interface 24 may enable the user equipment 10 to interface with various other user equipment or electronic devices, as may the network interface 26. In some embodiments, the I/O interface 24 may include an I/O port for a hardwired connection for charging and/or content manipulation using a standard connector and protocol, such as the Lightning connector provided by Apple Inc. of Cupertino, California, a universal serial bus (USB), or other similar connector and protocol. The network interface 26 may include, for example, one or more interfaces for a personal area network (PAN), such as an ultra-wideband (UWB) or a BLUETOOTH® network, a local area network (LAN) or wireless local area network (WLAN), such as a network employing one of the IEEE 802.11x family of protocols (e.g., WI-FI®), and/or a wide area network (WAN), such as any standards related to the Third Generation Partnership Project (3GPP), including, for example, a 3^{rd} generation (3G) cellular network, universal mobile telecommunication system (UMTS), 4^{th} generation (4G) cellular network, long term evolution (LTE®) cellular network, long term evolution license assisted access (LTE-LAA) cellular network, 5^{th} generation (5G) cellular network, and/or New Radio (NR) cellular network, a 6^{th} generation (6G) or greater than 6G cellular network, a satellite network, a non-terrestrial network, and so on. In particular, the network interface 26 may include, for example, one or more interfaces for using a cellular communication standard of the 5G specifications that include the millimeter wave (mmWave) frequency range (e.g., 24.25-300 gigahertz (GHz)) that defines and/or enables frequency ranges used for wireless communication. The network interface 26 of the user equipment 10 may allow communication over the aforementioned networks (e.g., 5G, Wi-Fi, LTE-LAA, and so forth).

The network interface 26 may also include one or more interfaces for, for example, broadband fixed wireless access networks (e.g., WIMAX®), mobile broadband Wireless networks (mobile WIMAX®), asynchronous digital subscriber lines (e.g., ADSL, VDSL), digital video broadcasting-terrestrial (DVB-T®) network and its extension DVB Handheld (DVB-H®) network, ultra-wideband (UWB) network, alternating current (AC) power lines, and so forth.

As illustrated, the network interface 26 may include a transceiver 30. In some embodiments, all or portions of the transceiver 30 may be disposed within the processor 12. The transceiver 30 may support transmission and receipt of various wireless signals via one or more antennas, and thus may include a transmitter and a receiver. The power source 29 of the user equipment 10 may include any suitable source of power, such as a rechargeable lithium polymer (Li-poly) battery and/or an alternating current (AC) power converter.

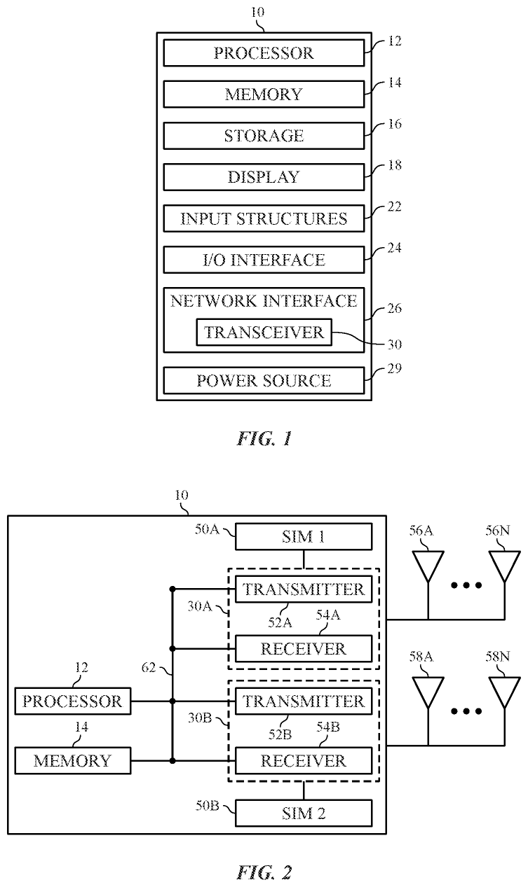

FIG. 2 is a functional diagram of the user equipment 10 of FIG. 1 having multiple subscriber identity modules (SIMs) 50A, 50B (collectively 50), according to embodiments of the present disclosure. As illustrated, the processor 12, the memory 14, the transceivers 30A, 30B (collectively 30), transmitters 52A, 52B (collectively 52), receivers 54A, 54B (collectively 54), and/or antennas 56A-56N (collectively 56) and 58A-58N (collectively 58) may be communicatively coupled directly or indirectly (e.g., through or via another component, a communication bus, a network) to one another to transmit and/or receive signals between one another.

The user equipment 10 may include the transmitters 52 and/or the receivers 54 that respectively enable transmission and reception of signals between the user equipment 10 and an external device via, for example, a network (e.g., including base stations or access points) or a direct connection. As illustrated, a transmitter 52 and a receiver 54 may be combined into a transceiver 30. The user equipment 10 may also have one or more antennas 56, 58 electrically coupled to a respective transceiver 30. The antennas 56, 58 may be configured in an omnidirectional or directional configuration, in a single-beam, dual-beam, or multi-beam arrangement, and so on. Each antenna 56, 58 may be associated with one or more beams and various configurations. In some embodiments, multiple antennas of the antennas 56, 58 of an antenna group or module may be communicatively coupled to a respective transceiver 30 and each emit radio frequency signals that may constructively and/or destructively combine to form a beam. The user equipment 10 may include any suitable number of transmitters, receivers, transceivers, and/or antennas for various communication standards. In some embodiments, a transmitter 52 and receiver 54 may transmit and receive information via other wired or wireline systems or means.

Each SIM 50 may be associated with a respective and different operator core network, and store an international mobile subscriber identity (IMSI) number and its related key, which is used to identify and authenticate subscribers on the core network. As illustrated, a first transceiver 30A may be communicatively coupled to a first SIM 50A, and may use the first SIM 50A (e.g., the IMSI number and its related key) to transmit signals using a first transmitter 52A and receive signals using a first receiver 54A to and from a first network via the antennas 56. A second transceiver 30B may be communicatively coupled to a second SIM 50B, and may use the second SIM 50B (e.g., the IMSI number and its related key) to transmit signals using a second transmitter 52B and receive signals using a first receiver 54B to and from a second network via the antennas 58. While the present disclosure refers to the user equipment 10 having two SIMs 50, it should be understood that it is contemplated that the user equipment 10 may have any suitable number of SIMs 50 greater than one, such as three or more SIMs 50, four or more SIMs 50, five or more SIMs 50, ten or more SIMs 50, and so on (and respectively coupled transceivers 30).

As illustrated, the various components of the user equipment 10 may be coupled together by a bus system 62. The bus system 62 may include a data bus, for example, as well as a power bus, a control signal bus, and a status signal bus, in addition to the data bus. The components of the user equipment 10 may be coupled together or accept or provide inputs to each other using some other mechanism.

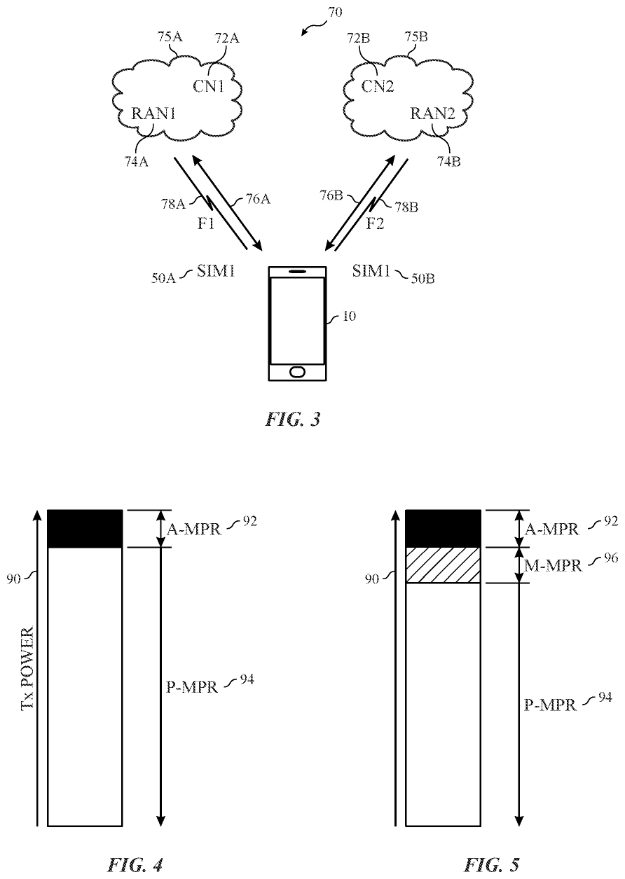

In its release 17 (Rel-17), the 3GPP addressed downlink operations for multi-SIM (MuSIM) user equipment that may receive signals using only one SIM 50 at a given time or two SIMs 50 simultaneously. However, the 3GPP has not addressed multiple simultaneous uplink operations using MuSIM user equipment (e.g., 10). FIG. 3 is a schematic diagram of a wireless communication system 70 including the user equipment 10 of FIG. 1, according to embodiments of the present disclosure. The first SIM 50A (SIM1) of the user equipment 10 is associated with a first operator core network 72A (CN1), and the second SIM 50B (SIM2) of the user equipment 10 is associated with a second operator core network 72B (CN2). The first core network 72A also includes a first radio access network 74A (RAN1), and the second core network 72B includes a second radio access network 74B (RAN2). The radio access networks (RANs) 74A, 74B (collectively 74) manage user equipment (including the user equipment 10) at a wireless level. The first core network 72A and the first RAN 74A may be collectively referred to as a first network 75A, while the second core network 72B and the second RAN 74B may be collectively referred to as a first network 75B. It should be understood that an operator of the first core network 72A may not communicate with, nor even be aware of, the second core network 72B, and an operator of the second core network 72B may not communicate with, nor even be aware of, the first core network 72A. The core networks 72A, 72B (collectively 72) and the RANs 74 may be associated with any suitable wireless communication network, such as a 4G/LTE network, a 5G/NR network, a 6G network, a beyond 6G network, a 2G network, a 3G network, and so on.

The user equipment 10 may transmit and/or receive signals 76A using a first frequency 78A (F #1) associated with the first SIM 50A, and may transmit and/or receive signals 76B using a second frequency 78B (F #2) associated with the second SIM 50B. As such, the first frequency 78A may be allocated and managed by the first RAN network 74A, and the second frequency 78B may be allocated and managed by the second RAN network 74B. In some embodiments, the first frequency 78A and the second frequency 78B may be different frequencies within the same frequency band. In additional or alternative embodiments, the first frequency 78A and the second frequency 78B may be different frequencies within the different frequency bands.

Initially, the user equipment 10 may activate both SIMs 50 and registers with the first core network 72A via the first SIM 50A and registers with the second core network 72B via the second SIM 50B. The user equipment 10 may then be in an idle or inactive state (e.g., in a Radio Resource Control (RRC) idle state (RRC_IDLE state) or in an RRC inactive state (RRC_INACTIVE state)). The user equipment 10 may listen to a first paging channel on the first network 75A via the first frequency 78A and a second paging channel on the second network 75B via the second frequency 78B. Each network 75A, 75B (collectively 75) may send mobile-terminated notifications (e.g., paging messages) on its paging channel that may trigger actions by the user equipment 10.

After reception of a mobile-terminated notification on a paging channel associated with a SIM 50, the user equipment 10 may enter an active or connected state (e.g., an RRC connected state (RRC_CONNECTED state)) on that SIM 50. The user equipment 10 may then transmit and/or receive signals with the RAN 74 associated with the SIM 50. Concurrently or simultaneously, the user equipment 10 may continue to listen to the paging channel associated with the other SIM 50. In some cases, the user equipment 10 may be asked by both radio access networks 74 to enter the connected state on both SIMs 50. In this case, the user equipment 10 may transmit signals (e.g., having uplink data) associated with both SIMs 50.

Implementing signal transmission (e.g., simultaneously or concurrently) associated with both SIMs 50 may encounter several technical challenges. For user equipment capable of transmitting signals only over one SIM 50 at a given time, the user equipment may only operate one transmitter 52 at the given time. This may be performed in a coordinated or uncoordinated fashion (with respect to the other transmitter 52). For user equipment (e.g., including the user equipment 10) capable of transmitting signals over two SIMs 50 at a given time, the user equipment 10 may share its transmission power between its two transmitters 52 associated with the SIMs 50. Moreover, depending on a combination of the first frequency 78A and the second frequency 78B, the user equipment 10 may further restrict its transmission power. One solution is for the user equipment 10 to decrease its transmission power (e.g., perform power back-off). However, decreasing transmission power for MuSIM operation is a new framework for the 3GPP, because the first network 75A does not know about the second network 75B. That is, the 3GPP rarely considers interoperability between two networks 75. As such, MuSIM operations may not be adequately addressed by the 3GPP.

In particular, if the user equipment 10 is configured (e.g., by one or both radio access networks 74) for a target (e.g., maximum) transmission power, but it cannot sustain the target transmission power for each SIM 50, the user equipment 10 decrease its transmission power from the target transmission power for each SIM 50. That is, the user equipment 10 may perform a power back-off for each SIM 50.

Moreover, transmission using the first SIM 50A at the first frequency 78A and transmission using the second SIM 50B at the second frequency 78B may result in intermodulation issues. That is, transmitting signals at the first frequency 78A using the first SIM 50A may cause amplitude modulation with signals transmitted at the second frequency 78B using the second SIM 50B due to nonlinearities or time variance. As a result, the user equipment 10 may perform a power back-off for each SIM 50 to avoid intermodulation.

Further, the two scenarios described above may occur simultaneously. That is, the user equipment may perform a power back-off because it cannot sustain a target transmission power for each SIM 50, and may perform an additional power back-off because of intermodulation between transmitting signals at the first frequency 78A and the second frequency 78B.

Additionally or alternatively, if transmitting signals using the first SIM 50A at the first frequency 78A occurs simultaneously or concurrently with reception using the second SIM 50B at the second frequency 78B, the user equipment 10 may perform a power back-off with respect to the first SIM 50A to ensure sufficient quality (e.g., avoid interference with) reception using the second SIM 50B. In particular, the user equipment 10 may perform the power back-off if the first frequency 78A and the second frequency 78B are in the same frequency band (e.g., as specified by a specification, such as the 3GPP specification).

In each of these cases, the reduction in transmission power may violate existing specifications (e.g., the 3GPP specification), which may not allow such power back-off (e.g., due to MuSIM operation). That is, decreasing transmission power due to MuSIM operation is a new framework for certain specifications, including the 3GPP specification, as the first network 75A does not communicate with, and has no knowledge of, the second network 75B.

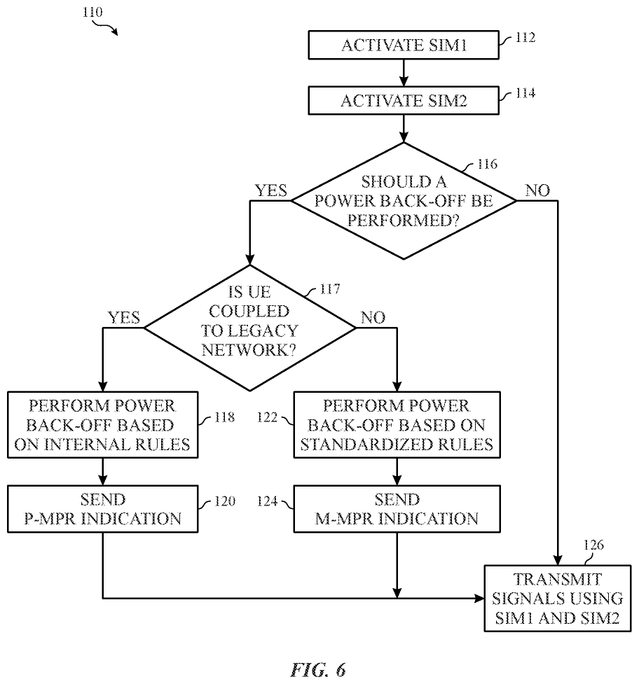

In some embodiments, an existing Power Management Maximum Power Reduction (P-MPR) framework may be leveraged to enable the user equipment 10 to perform power back-off without violating existing specifications. FIG. 4 is a schematic diagram of different maximum power reductions (MPRs) for transmission power 90 of the user equipment 10 as specified by a legacy specification (e.g., the Third Generation Partnership Project (3GPP) specification), according to embodiments of the present disclosure. A legacy specification, as referred to herein, may include a specification that does not support MuSIM operation or MuSIM user equipment 10. The legacy specification may provide a first MPR 92 (e.g., an additional MPR (A-MPR)) for decreasing transmission power at the user equipment 10. The A-MPR 92 may be defined by the specification, and, in some cases, may be dependent upon frequency band, channel, location of the frequency in the frequency band, and so on. For example, the A-MPR 92 may be 16 decibels (dB) or less, 6 dB or less, 5 dB or less, 3 dB or less, 1 dB or less, and so on. However, the legacy specification may restrict the user equipment 10 from decreasing power beyond the A-MPR 92, unless under specified circumstances. That is, the legacy specification may not allow the user equipment 10 to decrease its transmission power (e.g., perform a power back-off) beyond the A-MPR 92 for MuSIM operation, which may prevent the user equipment 10 from performing MuSIM operation (e.g., simultaneous or concurrent transmission using multiple SIMs 50).

However, the legacy specification may include a second MPR 94 (e.g., the P-MPR) that may be used under specified circumstances (e.g., to meet additional exposure requirements, such as to reduce exposure of a user to a radio frequency electromagnetic field emitted from antennas 56, 58 of the user equipment 10). Advantageously, the P-MPR may enable the user equipment 10 to decrease its transmission power any suitable amount (e.g., down to a transmission power of 0 dB). As such, the user equipment 10 may leverage the P-MPR framework to decrease its transmission power beyond the A-MPR 92 for MuSIM operation. In particular, the user equipment 10 may send a P-MPR indication to the radio access network 74 when performing a power back-off for MuSIM operation. This may be applicable when performing a power back-off for MuSIM operation is not standardized for an applicable specification (e.g., the 3GPP specification). In cases where using the P-MPR 94 for performing a power back-off for MuSIM operation is standardized (e.g., the 3GPP adopts using the P-MPR 94 for performing a power back-off for MuSIM operation), the 3GPP may also adopt a MuSIM-related indication that may enable the user equipment 10 to inform the radio access network 74 that it is using the P-MPR 94 for performing a power back-off for MuSIM operation (e.g., as opposed to using the P-MPR 94 for meeting additional exposure requirements). Such an indication may include the user equipment 10 transmitting a signal to the network 75, setting one or more bits in a signal, and so on.

Advantageously, this scheme may be used with legacy networks (e.g., those networks that are unaware of a user equipment's MuSIM feature or capability). Moreover, it may be a simple matter to implement this scheme for the user equipment 10, as it provide more freedom and flexibility for operation (e.g., the user equipment 10 decides when to perform a power back-off, and is not restricted by the radio access network 74). However, for this reason, this scheme may be coupled with less predictable user equipment behavior as perceived by the network 75.

In additional or alternative embodiments, a new framework for MuSIM user equipment may be implemented to enable the user equipment 10 to perform power back-off specified for MuSIM operation. FIG. 5 is a schematic diagram of different MPRs for transmission power of the user equipment 10 as specified by a proposed specification that supports user equipment having multiple SIMs, according to embodiments of the present disclosure. As illustrated, the transmission power may be decreased using the A-MPR 92 and the P-MPR 94 discussed above with respect to FIG. 4. Moreover, a third MPR 96 is introduced that is specified for use for MuSIM operation, referred to herein as MuSIM-MPR or M-MPR. The M-MPR 96 enables further reduction of transmission power beyond the A-MPR 92. As such, the relevant specification (e.g., the 3GPP specification) may provide for the M-MPR 96 to reduce transmission power at specified margins. For example, the user equipment 10 may perform a power back-off according to the M-MPR 96 in cases where it cannot sustain a target transmission power for each SIM 50, because of intermodulation between transmitting signals at the first frequency 78A and the second frequency 78B, and/or if transmitting signals using the first SIM 50A at the first frequency 78A occurs simultaneously or concurrently with reception using the second SIM 50B at the second frequency 78B, where the first frequency 78A and the second frequency 78B are in the same frequency band. In some embodiments, the 3GPP may adopt a MuSIM-related indication that may enable the user equipment 10 to inform the radio access network 74 that it is performing a power back-off using the M-MPR 96.

Advantageously, this scheme may enable more predictable user equipment behavior as perceived by the radio access network 74, as the radio access network 74 may be aware when the user equipment 10 is performing a power back-off due to MuSIM operation. Moreover, the amount of the power back-off may be defined by the relevant specification. However, with more predictability and network involvement comes more complexity to implement and activate this feature on the network-side, as well as efforts to incorporate into the specification.

FIG. 6 is a flowchart of a method 110 for performing a power back-off with a legacy wireless communication network (e.g., that does not support user equipment having multiple SIMs 50) and where the power back-off due to MuSIM operation is not standardized, and/or a MuSIM network, according to embodiments of the present disclosure. Any suitable device (e.g., a controller) that may control components of the user equipment 10, such as the processor 12, may perform the method 110. In some embodiments, the method 110 may be implemented by executing instructions stored in a tangible, non-transitory, computer-readable medium, such as the memory 14 or storage 16, using the processor 12. For example, the method 110 may be performed at least in part by one or more software components, such as an operating system of the user equipment 10, one or more software applications of the user equipment 10, and the like. While the method 110 is described using steps in a specific sequence, it should be understood that the present disclosure contemplates that the described steps may be performed in different sequences than the sequence illustrated, and certain described steps may be skipped or not performed altogether.

In process block 112, the user equipment 10 activates, supplies power to, or communicatively couples the first transceiver 30A to the first SIM 50A. In process block 114, the user equipment 10 activates, supplies power to, or communicatively couples the second transceiver 30B to the second SIM 50B.

In decision block 116, the user equipment 10 determines whether it should perform a power back-off, or receives an indication to perform a power back-off. In particular, the user equipment 10 may determine whether it cannot sustain a target transmission power for each SIM 50, whether there may be intermodulation (e.g., above a threshold degree of intermodulation) between transmitting signals at the first frequency 78A and the second frequency 78B, and/or whether transmitting signals using the first SIM 50A at the first frequency 78A occurs simultaneously or concurrently with reception using the second SIM 50B at the second frequency 78B, where the first frequency 78A and the second frequency 78B are in the same frequency band. In such cases, the user equipment 10 may determine to perform the power back-off or receive an indication to perform a power back-off. Otherwise, the user equipment 10 may determine that it need not perform the power back-off or the user equipment 10 may not receive an indication to perform a power back-off.

If the user equipment 10 determines that it should perform a power back-off or receives an indication to perform a power back-off, then, in decision block 117, the user equipment 10 determines, for each SIM 50, whether it is communicatively coupled to a legacy network or a MuSIM network. If, for a SIM 50, the user equipment 10 is coupled to a legacy network (e.g., a network that does not support MuSIM user equipment 10, or is unaware of a user equipment's MuSIM feature or capability), then, in process block 118, the user equipment 10 performs the power back-off based on internal rules. That is, it is assumed that MuSIM operation by the user equipment 10 has not been standardized (e.g., in a specification, such as the 3GPP specification), and, as such, the user equipment 10 may perform the power back-off using its own rules (e.g., rules or instructions programmed into the memory 14 or the storage 16 of the user equipment 10). Moreover, the user equipment 10 may perform the power back-off according to the legacy P-MPR framework. As an illustrative example, and referring back to FIG. 3, the first network 75A may include the legacy network, and the user equipment 10 may communicatively couple to the legacy network 75A via the first SIM 50A.

In process block 120, the user equipment 10 then sends a P-MPR indication to the legacy network, per the legacy P-MPR framework. Because MuSIM operation by the user equipment 10 has not been standardized for the legacy network, the user equipment 10 may not be able to provide an indication to the legacy network that it is performing the power back-off due to MuSIM operation. As such, the user equipment 10 may leverage the legacy P-MPR framework to decrease its transmission power beyond, for example, the A-MPR 92.

If, in decision block 117, for a SIM 50, the user equipment 10 determines that it is communicatively coupled to a MuSIM network (e.g., a network that does supports MuSIM user equipment 10, or is aware of a user equipment's MuSIM feature or capability), then, in process block 122, the user equipment 10 performs the power back-off based on standardized rules. That is, MuSIM operation has been standardized on the MuSIM network. As such, the applicable specification, such as the 3GPP specification, may include rules related to performing the power back-off, which may be followed by the user equipment 10. As an illustrative example, and referring back to FIG. 3, the second network 75B may include the MuSIM network, and the user equipment 10 may communicatively couple to the MuSIM network 75B via the second SIM 50B.

In process block 124, the user equipment 10 then sends an M-MPR indication to the MuSIM network, per a new M-MPR framework. The indication may inform the MuSIM network that the user equipment 10 is performing the power back-off due to MuSIM operation (e.g., because it cannot sustain a target transmission power for each SIM 50, because there may be intermodulation (e.g., above a threshold degree of intermodulation) between transmitting signals at the first frequency 78A and the second frequency 78B, and/or because transmitting signals using the first SIM 50A at the first frequency 78A occurs simultaneously or concurrently with reception using the second SIM 50B at the second frequency 78B, where the first frequency 78A and the second frequency 78B are in the same frequency band).

In process block 126, the user equipment 10 transmits signals using the SIMs 50. In particular, the user equipment 10 may transmit signals to the first network 75A using the first SIM 50A and to the second network 75B using the second SIM 50B. Referring back to decision block 116, if the user equipment 10 determines that it need not perform a power back-off, or does not receive an indication to perform a power back-off, then, in process block 126, the user equipment 10 also transmits signals using the SIMs 50. In this manner, the method 110 enables the user equipment 10 to perform a power back-off with a legacy wireless communication network (e.g., that does not support user equipment having multiple SIMs 50) and where the power back-off due to MuSIM operation is not standardized, and/or a MuSIM network.

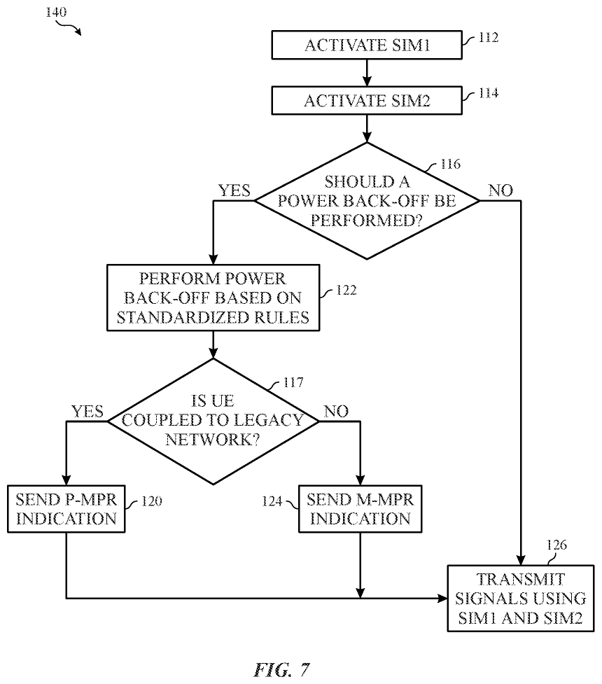

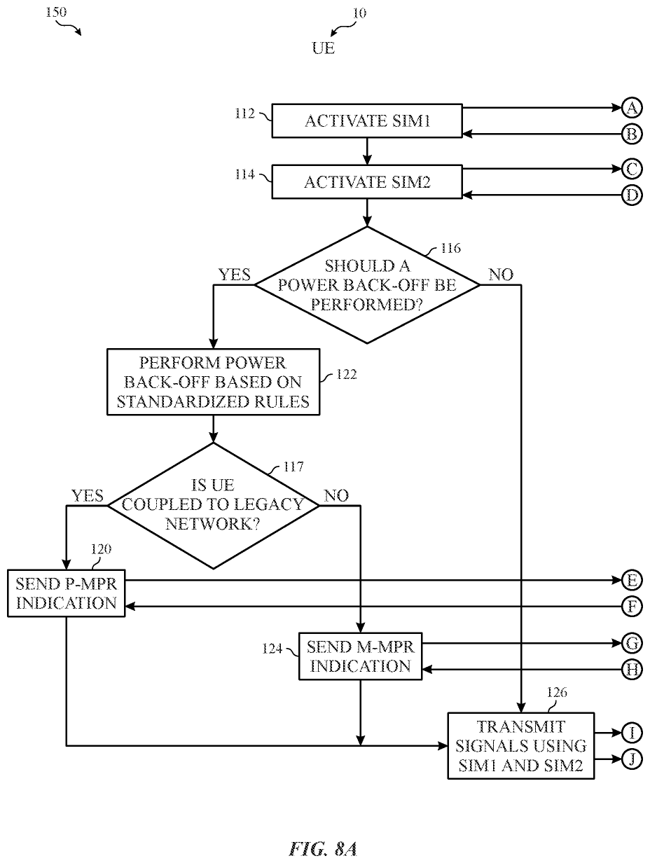

FIG. 7 is a flowchart of a method 140 for performing a power back-off with a legacy wireless communication network and where the power back-off due to MuSIM operation is standardized, and/or a MuSIM network, according to embodiments of the present disclosure. Any suitable device (e.g., a controller) that may control components of the user equipment 10, such as the processor 12, may perform the method 140. In some embodiments, the method 140 may be implemented by executing instructions stored in a tangible, non-transitory, computer-readable medium, such as the memory 14 or storage 16, using the processor 12. For example, the method 140 may be performed at least in part by one or more software components, such as an operating system of the user equipment 10, one or more software applications of the user equipment 10, and the like. While the method 140 is described using steps in a specific sequence, it should be understood that the present disclosure contemplates that the described steps may be performed in different sequences than the sequence illustrated, and certain described steps may be skipped or not performed altogether.

In process block 112, the user equipment 10 activates, supplies power to, or communicatively couples the first transceiver 30A to the first SIM 50A. In process block 114, the user equipment 10 activates, supplies power to, or communicatively couples the second transceiver 30B to the second SIM 50B. In decision block 116, the user equipment 10 determines whether it should perform a power back-off, or receives an indication to perform a power back-off, as described above with respect to the method 110 illustrated in FIG. 6.

If the user equipment 10 determines that it should perform a power back-off or receives an indication to perform a power back-off, then, in process block 122, the user equipment 10 performs the power back-off based on standardized rules. That is, MuSIM operation has been standardized on both the legacy network and the MuSIM network. For instance, in the case of the legacy network, the specification (e.g., the 3GPP specification) may adopt the use of the P-MPR framework to enable the user equipment 10 to perform a power back-off for MuSIM operation.

In decision block 117, the user equipment 10 then determines, for each SIM 50, whether it is communicatively coupled to a legacy network or a MuSIM network. If, for a SIM 50, the user equipment 10 is coupled to a legacy network, then, in process block 120, the user equipment 10 sends a P-MPR indication to the legacy network, per the legacy P-MPR framework. Additionally, in some embodiments, the 3GPP may adopt a MuSIM-related indication that may enable the user equipment 10 to inform the legacy network that it is performing a power back-off using the M-MPR 96. In such embodiments, the user equipment 10 may also send the MuSIM-related indication to the legacy network to inform the legacy network that it is performing the power back-off for MuSIM operation. As such, the user equipment 10 may leverage the legacy P-MPR framework to decrease its transmission power beyond, for example, the A-MPR 92.

If, in decision block 117, for a SIM 50, the user equipment 10 determines that it is communicatively coupled to a MuSIM network (e.g., a network that does supports MuSIM user equipment 10, or is aware of a user equipment's MuSIM feature or capability), then, in process block 124, the user equipment 10 sends an M-MPR indication to the MuSIM network, per a new M-MPR framework, as described above with respect to the method 110 illustrated in FIG. 6.

In process block 126, the user equipment 10 transmits signals using the SIMs 50. In particular, the user equipment 10 may transmit signals to the first network 75A using the first SIM 50A and to the second network 75B using the second SIM 50B. Referring back to decision block 116, if the user equipment 10 determines that it need not perform a power back-off, or does not receive an indication to perform a power back-off, then, in process block 126, the user equipment 10 also transmits signals using the SIMs 50. In this manner, the method 140 enables the user equipment 10 to perform a power back-off with a legacy wireless communication network and where the power back-off due to MuSIM operation is standardized, and/or a MuSIM network.

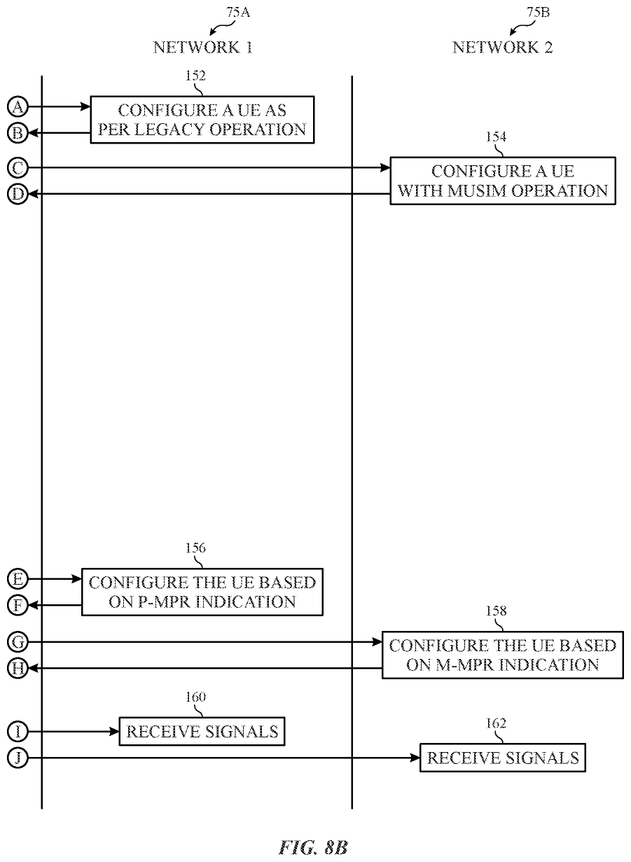

FIGS. 8A and 8B are a flowchart of a method 150 that illustrates actions by the user equipment 10, a legacy network, and a MuSIM network, when the user equipment 10 performs the method 140 of FIG. 7, according to embodiments of the present disclosure. While the user equipment 10 performs the method 140 of FIG. 7, it should be understood that similar actions may be performed by the user equipment 10, a legacy network, and a MuSIM network, when the user equipment 10 performs a power back-off via other methods, including the method 110 of FIG. 6. In particular, processors 12 of computing devices (including base stations) of the legacy network and/or the MuSIM network may perform at least some process or decision blocks of the method 150. Moreover, the first network 75A is provided as an example of the legacy network, and the second network 75B is provided as an example of the MuSIM network, though it should be understood that, in additional or alternative embodiments, the networks 75 may be reversed, both networks 75 may include legacy networks, or both networks may include MuSIM networks.

As illustrated, when the user equipment 10 activates the first SIM 50A in process block 112 as described above with respect to the method 110 of FIG. 6, the legacy network 72A, in process block 152, configures the user equipment 10 as per legacy operation (e.g., to operate on the legacy network 72A). Similarly, when the user equipment 10 activates the second SIM 50B in process block 114 as described above with respect to the method 110 of FIG. 6, the MuSIM network 72B, in process block 154, configures the user equipment 10 as per MuSIM operation (e.g., to operate on the MuSIM network 72B).

If the user equipment 10 determines that it should perform a power back-off (in decision block 116) and, for a SIM 50, the user equipment 10 determines that it is communicatively coupled to a legacy network (in decision block 117), then the user equipment 10, in process block 120, sends a P-MPR indication to the legacy network, per the legacy P-MPR framework. In process block 156, the legacy network 72A may receive the P-MPR indication, and configure the user equipment 10 based on the P-MPR indication. For example, the legacy network 72A may avoid configuring the user equipment 10 for a higher or maximum transmission power when it receives the P-MPR indication, as the user equipment 10 has indicated it is decreasing its transmission power. In some embodiments, the 3GPP may adopt a MuSIM-related indication that may enable the user equipment 10 to inform the legacy network that it is performing a power back-off using the M-MPR 96. In such embodiments, the user equipment 10 may also send the MuSIM-related indication to the legacy network to inform the legacy network that it is performing the power back-off for MuSIM operation. As such, the user equipment 10 may leverage the legacy P-MPR framework to decrease its transmission power beyond, for example, the A-MPR 92. In such embodiments, the legacy network 75A may receive MuSIM-related indication, and configure the user equipment 10 based on the MuSIM-related indication (e.g., by avoiding configuring the user equipment 10 for a higher or maximum transmission power when it receives the MuSIM-related indication).

If the user equipment 10 determines that it should perform a power back-off (in decision block 116) and, for a SIM 50, the user equipment 10 determines that it is communicatively coupled to a MuSIM network (in decision block 117), then the user equipment 10, in process block 124, sends an M-MPR indication to the MuSIM network, per a new M-MPR framework, as described above with respect to the method 110 illustrated in FIG. 6. In process block 158, the MuSIM network 75B may receive the M-MPR indication, and configure the user equipment 10 based on the M-MPR indication. For example, the MuSIM network 75B may avoid configuring the user equipment 10 for a higher or maximum transmission power when it receives the M-MPR indication, as the user equipment 10 has indicated it is decreasing its transmission power. In process block 126, the user equipment 10 transmits signals using the SIMs 50. In particular, the user equipment 10 may transmit signals to the legacy network 75A using the first SIM 50A and to the MuSIM network 75A using the second SIM 50B. In this manner, the method 150 that illustrates actions by the user equipment 10, a legacy network, and a MuSIM network, when the user equipment 10 performs the method 140 of FIG. 7.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. User equipment, comprising:
a first transmitter;
a second transmitter;
a first subscriber identity module (SIM) communicatively coupled to the first transmitter;
a second SIM communicatively coupled to the second transmitter; and
processing circuitry communicatively coupled to the first transmitter and the second transmitter, the processing circuitry configured to
transmit, using the first transmitter and the first SIM, a first indication of a first transmission power reduction,
transmit, using the second transmitter and the second SIM, a second indication of a second transmission power reduction,
decrease a first transmission power at the first transmitter,
decrease a second transmission power at the second transmitter,
transmit, using the first transmitter and the first SIM, a first signal, and
transmit, using the second transmitter and the second SIM, a second signal.

2. The user equipment of claim 1, wherein the processing circuitry is configured to transmit, using the first transmitter and the first SIM, the first signal while transmitting, using the second transmitter and the second SIM, the second signal.

3. The user equipment of claim 1, wherein the processing circuitry is configured to transmit, using the first transmitter and the first SIM, the first indication of the first transmission power reduction, and transmit, using the second transmitter and the second SIM, the second indication of the second transmission power reduction based on receiving an indication to decrease transmission power at the first transmitter, the second transmitter, or both.

4. The user equipment of claim 1, wherein the processing circuitry is configured to determine to decrease transmission power at the first transmitter, the second transmitter, or both based on an inability to sustain a target transmission power at the first transmitter and the second transmitter.

5. The user equipment of claim 1, wherein the processing circuitry is configured to determine to decrease transmission power at the first transmitter, the second transmitter, or both in accordance with specified margins.

6. The user equipment of claim 1, wherein the first SIM is associated with a first frequency, and the second SIM is associated with a second frequency.

7. The user equipment of claim 6, wherein the processing circuitry is configured to determine to decrease transmission power at the first transmitter, the second transmitter, or both based on intermodulation between the first frequency and the second frequency.

8. The user equipment of claim 1, comprising a receiver communicatively coupled to the second SIM, wherein the processing circuitry is configured to determine to decrease transmission power at the first transmitter, the second transmitter, or both based on the first transmitter transmitting the first signal while the receiver receives a third signal.

9. The user equipment of claim 1, wherein the first SIM is associated with a first network, and the second SIM is associated with a second network.

10. The user equipment of claim 9, wherein the first network supports using the user equipment with multi-SIM operation.

11. The user equipment of claim 9, wherein the second network does not support the user equipment with multi-SIM operation.

12. A method performed by user equipment, comprising:
activating, via processing circuitry of the user equipment, a first subscriber identity module (SIM) of the user equipment;
activating, via the processing circuitry, a second SIM of the user equipment;
transmitting, via a first transmitter of the user equipment and the first SIM, a first indication of a first transmission power reduction based on using the first SIM and the second SIM;
decreasing, via the processing circuitry, first transmission power at the first transmitter; and
transmitting, via the first transmitter and the first SIM, a first signal.

13. The method of claim 12, comprising determining, via the processing circuitry, that the first SIM is associated with a first communication network that supports using the first SIM and the second SIM, wherein transmitting, via the first transmitter and the first SIM, the first indication of the first transmission power reduction is based on using the first SIM and the second SIM.

14. The method of claim 12, comprising transmitting, via a second transmitter of the user equipment and the second SIM, a second indication of a second transmission power reduction that is not based on using the first SIM and the second SIM.

15. The method of claim 14, wherein the second indication of the second transmission power reduction is based on meeting exposure requirements.

16. The method of claim 14, wherein the second indication of the second transmission power reduction comprises a Power Management Maximum Power Reduction indication.

17. The method of claim 14, comprising determining, via the processing circuitry, that the second SIM is associated with a second communication network that does not support the user equipment with multi-SIM operation, wherein transmitting, via the second transmitter and the second SIM, the second indication of the second transmission power reduction is based on the second communication network not supporting the user equipment with multi-SIM operation.

18. A method performed by an electronic device of a network, comprising:
receiving a first indication that user equipment has activated a first subscriber identity module (SIM);
receiving a second indication that the user equipment is decreasing transmission power based on using the first SIM and a second SIM; and
configuring the user equipment based on the second indication.

19. The method of claim 18, wherein the network is associated with the first SIM.

20. The method of claim 18, wherein the network is not associated with the second SIM.
